(19) United States
(12) Patent Application Publication
(10) Pub. No.: US 2025/0334787 A1
(43) Pub. Date: Oct. 30, 2025

(54) ADJUSTABLE REFLECTOR MODULE FOR A FOLDED LIGHT PATH OPTIC

(71) Applicant: LEUPOLD & STEVENS, INC., Beaverton, OR (US)

(72) Inventors: Xuyen HUYNH, Beaverton, OR (US); Martin KOORNNEEF, Beaverton, OR (US)

(21) Appl. No.: 19/182,475

(22) Filed: Apr. 17, 2025

Related U.S. Application Data
(60) Provisional application No. 63/638,161, filed on Apr. 24, 2024.

(51) Int. Cl. G02B 23/02

(52) U.S. Cl. CPC G02B 23/02

(57) ABSTRACT

Various embodiments described herein may include an adjustable reflector module installable in an opening defined by single or plural piece molded housing containing an objective lens assembly and a non-coaxial additional lens assembly, the adjustable reflector module comprising: a body to, together with the single or plural piece molded housing, define a cavity; a reflector on an interior side of the body, the reflector located in the cavity when the adjustable reflector module is installed in the opening, the reflector to redirect light processed by the objective lens assembly to the additional lens assembly; an adjustment interface on an exterior side of the body, the adjustment interface to pivot the reflector relative to the body. Other embodiments may be disclosed and/or claimed.

### RELATED APPLICATIONS

This application claims priority to U.S. Provisional Application No. 63/638,161 filed on Apr. 24, 2024, which is incorporated by reference herein. Some of the subject matter of this application is related to subject matter described in U.S. Non-Provisional application Ser. No. 18/412,349, filed on Jan. 12, 2024, which is incorporated by reference herein.

### TECHNICAL FIELD

The field of the present disclosure relates generally to optical devices, and more particularly to optics using internal reflectors, such as optics having folded light paths.

### BACKGROUND

Folded optics have an optical system that bends a beam to provide an optical path that may be longer than the optical system. This may provide a desired objective focal length in a small form factor.

### BRIEF DRAWINGS DESCRIPTION

The accompanying drawings, wherein like reference numerals represent like elements, are incorporated in and constitute a part of this specification and, together with the description, explain the advantages and principles of the presently disclosed technology.

FIG. 1A illustrates an isometric view of a folded optic housing, according to various embodiments.

FIG. 1B illustrates an end view of the folded optic housing of FIG. 1A.

FIG. 1C illustrates a section view of the folded optic housing taken along section line B-B of FIG. 1B.

FIG. 2A illustrates an isometric view of a folded optic with a housing having integrally formed channel sections, according to various embodiments.

FIG. 2B is an exploded view of the folded optic of FIG. 2A.

FIG. 2C is an end view of the folded optic of FIG. 2A.

FIG. 2D is a cross section view of the folded optic of FIG. 2A.

FIG. 3A is an end view of a folded optic housing in which a distance between center axes of openings of the folded optic housing is greater than one half of a sum of widths of the openings of the folded optic housing.

FIG. 3B is an end view of a folded optic housing in which a distance between center axes of openings of the folded optic housing is less than one half of a sum of widths of the openings of the folded optic housing.

FIG. 4A is a cross section view of the folded optic housing of FIG. 3A taken along section line B′ of FIG. 3A.

FIG. 4B is a cross section view of the folded optic housing of FIG. 3B taken along section line A′ of FIG. 3B.

FIG. 5 is a cross section view of an adjustable reflector module installed in a threaded opening defined by a folded optic housing, according to various embodiments.

FIG. 6 is an exploded view of the adjustable reflector module of FIG. 5.

FIG. 7 is an isometric view of a folding attachment assembly that may be used in combination with any optic housing described herein, in the unfolded state, according to various embodiments.

FIG. 8A is top isometric view of the folding attachment assembly of FIG. 7, in the folded state.

FIG. 8B is a section view of the folding attachment assembly of FIG. 7 in the folded state.

FIG. 9 is a bottom isometric view of the folding attachment assembly of FIG. 7 in the folded state.

FIG. 10A and FIG. 10B are bottom views of the folding attachment assembly of FIG. 7 in the locked and unlocked states, respectively, when folded.

FIG. 11A and FIG. 11B are section views of FIGS, 10A and 10B, respectively.

### DETAILED DESCRIPTION

With reference to the drawings, this section describes particular embodiments and their detailed construction and operation. Throughout the specification, reference to “one embodiment,” “an embodiment,” or “some embodiments” means that a particular described feature, structure, or characteristic may be included in at least one embodiment. Thus appearances of the phrases “in one embodiment,” “in an embodiment,” or “in some embodiments” in various places throughout this specification are not necessarily all referring to the same embodiment. Furthermore, the described features, structures, and characteristics may be combined in any suitable manner in one or more embodiments. In view of the disclosure herein, those skilled in the art will recognize that the various embodiments can be practiced without one or more of the specific details or with other methods, components, materials, or the like. In some instances, well-known structures, materials, or operations are not shown or not described in detail to avoid obscuring aspects of the embodiments.

Spotting scope housings may be made from metal or plastic. However, the choice of material may impact the method of manufacture of the housing. For example, in the case of metal housings, the use of aluminum may allow a housing to be formed by machining from billet, or a combination of casting and machining.

Magnesium is significantly lighter than aluminum-a magnesium housing for the spotting scope may weight eight ounces less than the same housing in aluminum. Magnesium can be cast with thinner walls, lower porosity and better mechanical properties than typical aluminum cast alloys. As such, magnesium housings are desirable for various folded optic applications.

For a number of reasons, with known magnesium spotting scopes, the housing may be formed by die-casting two separate pieces. These two pieces may then be joined together using a post-molding joining process (such as an adhesion process or other joining process to join two molded components).

These known magnesium spotting scopes may also have eyepiece and erector assemblies, which may be attached to the magnesium housing. Known two-piece magnesium housings with having eyepiece/erector assemblies may allow some movement of one or more of the assemblies in relation to the housing. When the spotting scope has an internal reticle, his movement may result in misalignment of externally mounted devices such as rangefinders in relation to the internal reticle, which may prevent the reticle from functioning as an accurate aiming device for the laser rangefinder.

Some other disadvantages of various known magnesium spotting scopes may include:
A shape of some known housings may allow ambient light to pass straight from the objective into the front element of the eyepiece/erector assembly;
The magnesium housing may be prone to galvanic corrosion if not protected by a covering finish and in contact with a dissimilar metal (e.g., if the magnesium of the housing is in contact with a fastener of a dissimilar metal); and/or
The housing may leak because of insufficient adhesive bond and/or gasket seal.

Various embodiments described herein may utilize new housing architecture/design optimized for single-piece molding. This new housing architecture/design allows a spotting scope housing to be formed by molding a single piece (e.g., die-casting a single magnesium piece or injection molding a single plastic piece). This may eliminate the post-molding joining processes, such as the adhesion process used in known two-piece constructions. A folded optic having a housing manufactured from a single molded piece may be lightweight, and may avoid one or more of the disadvantages of plural-piece housings described herein, or otherwise associated with known spotting scopes with plural-molded-piece housings joined using post-molding process(es).

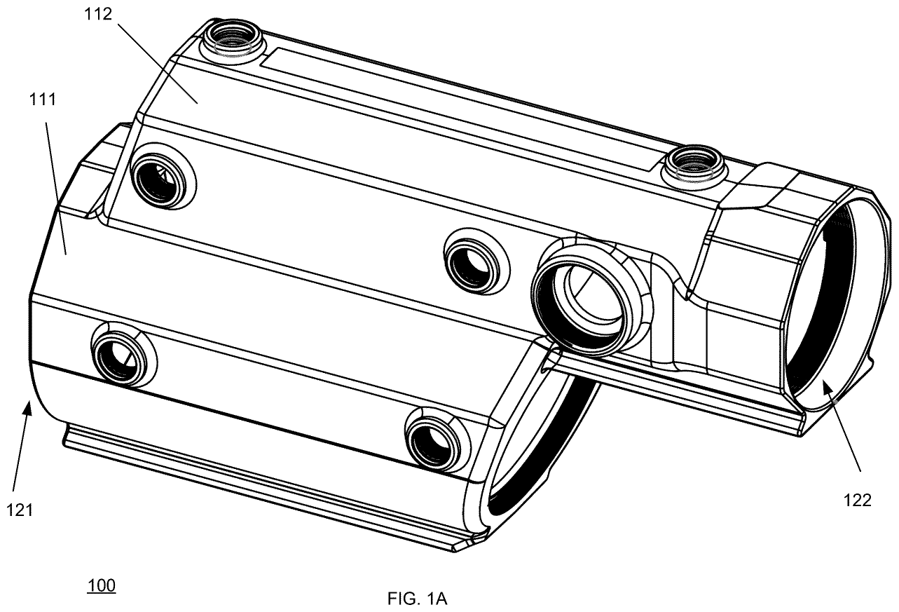

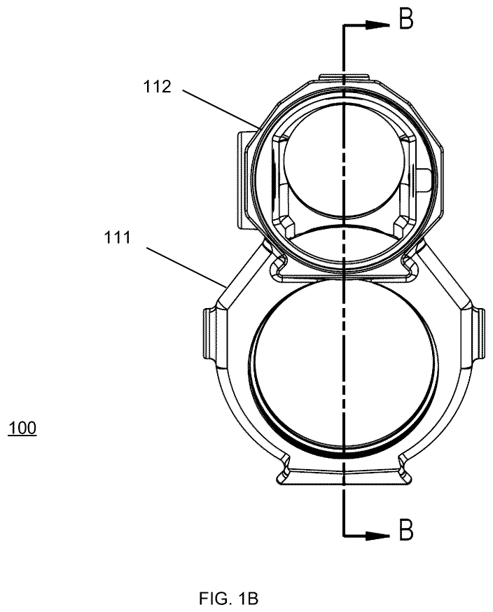

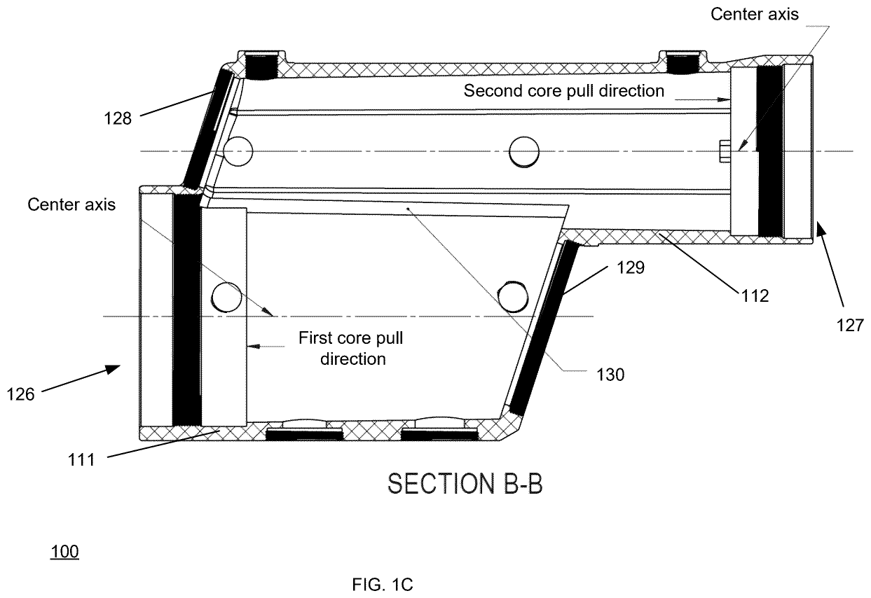

FIG. 1A illustrates an isometric view of a folded optic housing 100, according to various embodiments. FIG. 1B illustrates an end view of the folded optic housing 100 of FIG. 1A. FIG. 1C illustrates a section view of the folded optic housing 100 taken along section line B-B of FIG. 1B.

The housing 100 has non-coaxial channels provided by an objective channel section 111 and an additional channel section 112. The additional channel section 112 is integrally formed with the objective channel section 111. The housing 100 may be a single monolithic part, such as a monolithic magnesium manufacture or a monolithic plastic manufacture.

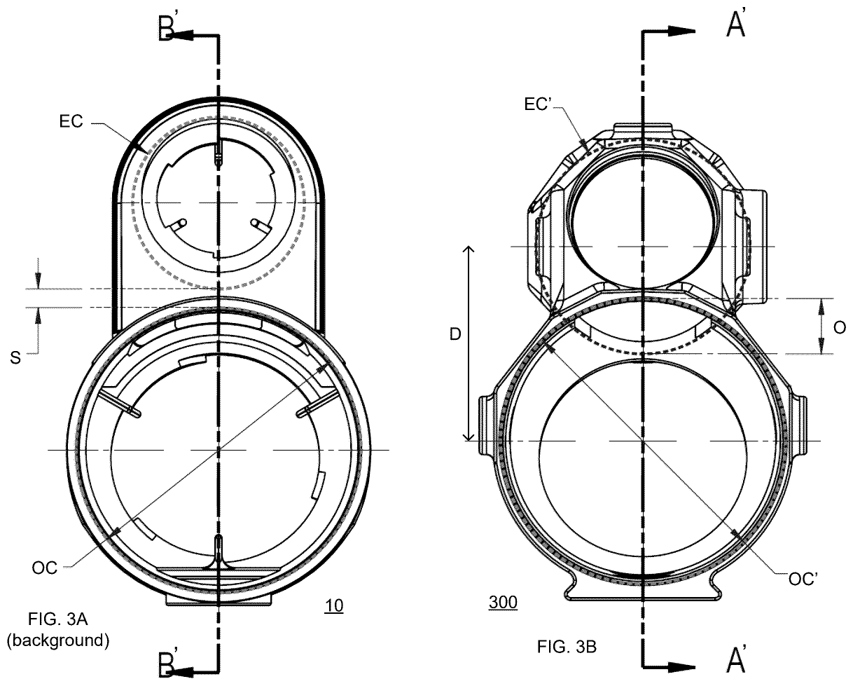

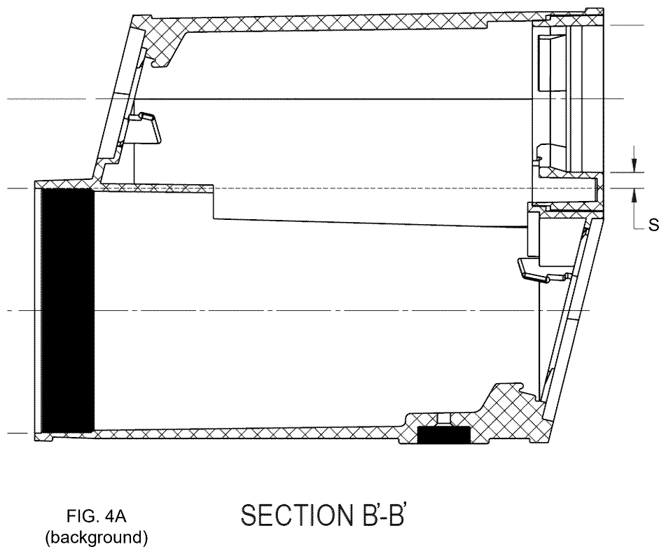

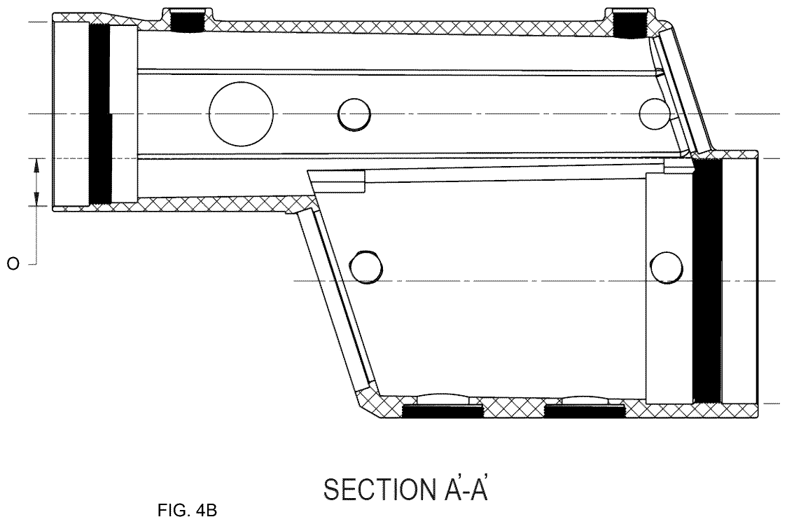

The housing 100 uses a different housing design/architecture than some known spotting scopes. This can best be seen by comparing FIGS. 3A and 4A (which illustrate end and cross sectional views, respectively, of a known spotting scope 10) and FIGS. 3B and 4B (which illustrate end and cross sectional views, respectively, of a spotting scope 300 similar in any respect to spotting scope 100 of FIG. 1A). FIG. 4B also illustrates the use of channel sidewalls having tapering thickness (the sidewalls thin approaching the core openings), which may support geometries optimized for single-piece molding processes.

In the known spotting scope architecture/design, the non-coaxial channels are spaced apart a distance S (FIGS. 3A and 4A), which may be greater than one sixth of an inch. In contrast, the spotting scope 300 (FIGS. 3B and 4B) may have channel center axes that are much closer together. In the illustrated example, the distance D is 1.851 inches, but other values may be used in other examples.

The openings at the opposite ends of the spotting scope 300 are not vertically spaced apart from each other like in the known spotting scope 10. Additionally, the spotting scope 300 includes an overlap O, which is not present on the spotting scope 10. In this example, the overlap O is 0.527 inches, but greater or less overlap amounts may be used.

In this example, a width of the objective channel OC' of spotting scope 300 at the corresponding opening may be the same size as the width of the objective channel OC of spotting scope 10. In this example, a width of the eyepiece channel EC' of the spotting scope 300 at the corresponding opening may be larger than a width of the objective channel EC of spotting scope 10 (e.g., 2.040 inches vs. 1.632 inches).

Referring again to FIG. 1A, the housing 100 includes an opening 121 with a width similar to a width of objective channel OC′ (FIG. 3A) and an opening 122 with a width similar to a width of eyepiece channel EC′ (FIG. 3B). The architecture/design of spotting scope 300 may be characterized by either or both of the following characteristics:
A distance D between channel axes that is not greater than one half of a sum of the widths of EC′ and OC′ (e.g., not greater than a sum of the radii of EC′ and OC′); and/or.
The presence of the overlap O of the openings.

Molding components/tools (i.e. devices used to fabricate a molded part) may include a mold and cores (such as die cores in the case of die casting). Cores are components that are typically used during molding to produce holes or openings. Referring to FIG. 1C, cores may be used to form the non-coaxial channels. For brevity, the cores are not shown in this illustration, but arrows are provided indicating the opposite core pull directions. A first core is pulled in a first direction (forming a first core opening 126), and a second core is pulled in a second opposite direction (forming second core opening 127).

One challenge of molding a monolithic housing for a folded optic may be to get the internal die cores close enough together to have a very thick web to machine out (as a thick web may form substantial porosity). The cores also need to be able to slide out of the housing unobstructed, without leaving thick areas of material (or there may be porosity). The cores may need to form a round hole in the front for a round objective lens, and a round hole in the upper channel on the back to support a round erector-eyepiece lens assembly. This may drive a need for a reduced distance between center axes of these channels.

However, reducing this distance (as compared to some known plural-piece housings) may also establish a distance that allows light from outside the field of view to enter the objective and directly enter the first element of the eyepiece-erector assembly. Unmanaged, this may result in veiling glare that may interfere with the image and, in certain lighting conditions may render it unusable. As a counter measure, asymmetric baffles may be used to block light traveling through the folded optic outside the image forming light path. In addition, some of the constructive, image-producing light may also be intentionally clipped as a tradeoff to assure good glare performance.

Referring again to FIG. 1C, due to the reduced distance between the center axes (as compared to some known plural-piece housings), the molding tooling (including the cores) may leave only a thin wall 130 between the channels. This thin wall 130 may be in the form of a thin web of material, which may be easily machined out without creating defects in the housing 100.

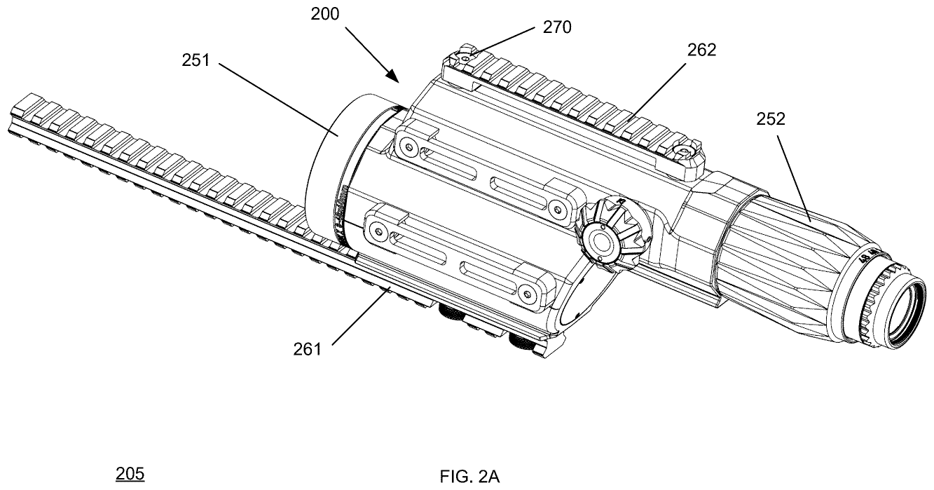

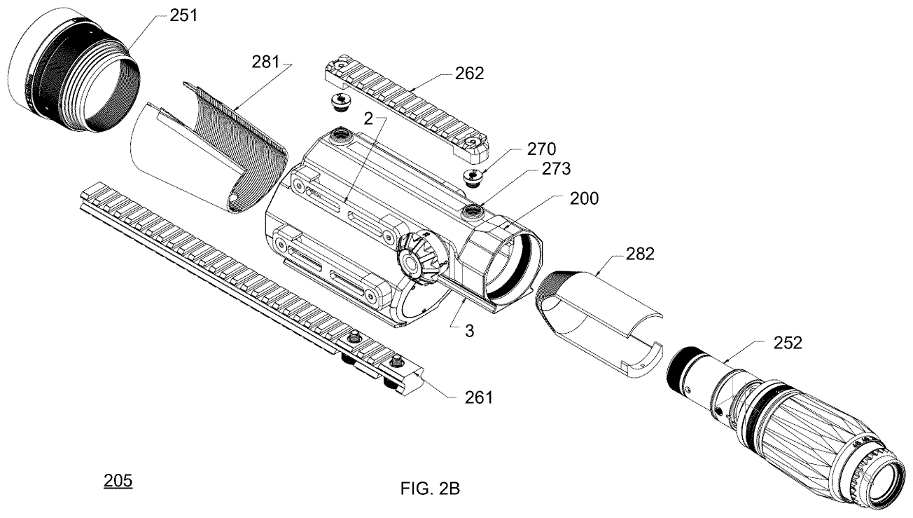

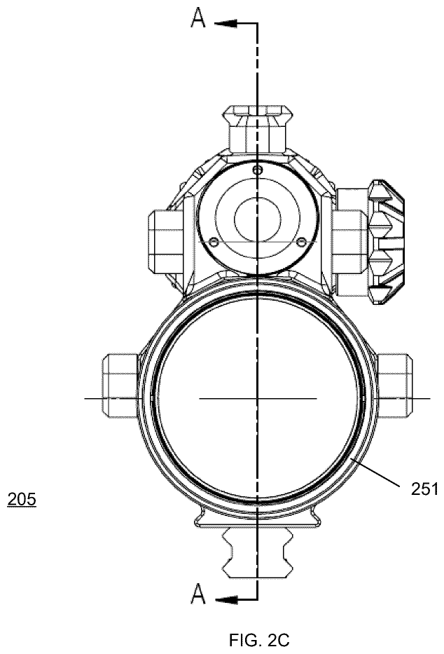

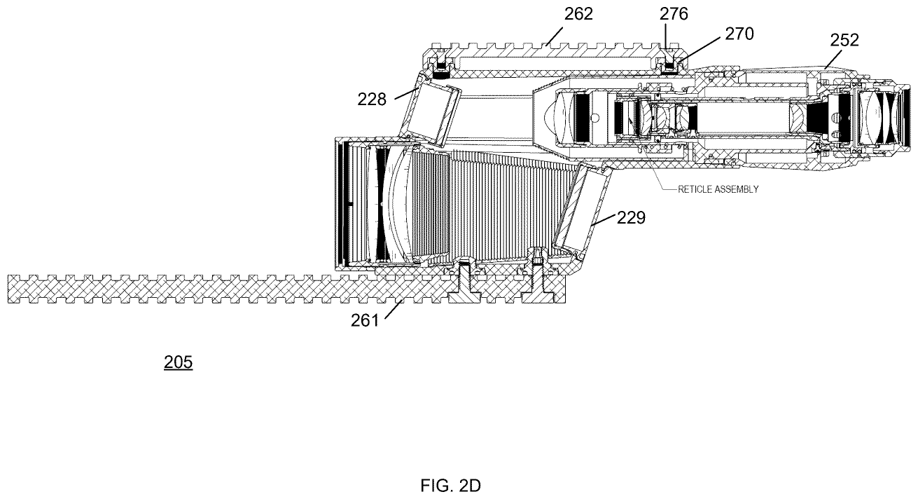

FIG. 2A illustrates an isometric view of a folded optic 205 with integrally formed channel sections, according to various embodiments. FIG. 2B is an exploded view of the folded optic 205 of FIG. 2A. FIG. 2C is an end view of the folded optic 205 of FIG. 2A. FIG. 2D is a cross section view of the folded optic 205 of FIG. 2A.

Referring to FIG. 2B, the housing 200 may be similar in any respect to housing 100 (FIGS. 1A-C). An objective lens assembly 251 and an eyepiece/erector assembly 252 may be located in core openings of the housing 200.

As described previously herein, the reduced distance between the center axes may affect optical characteristics of a folded optic using the monolithic molded housing. Asymmetric baffles 281 and 282 may be located in each core opening to block light traveling through the folded optic outside the image forming light path.

The folded optic 205 may include various external interfaces for mounting the folded optic and/or for mounting devices thereto (such as accessory rails). Any housing described herein may include attachment point(s) for accessory rails, which may include through holes 273 and adapters 270 (e.g., ring-shaped adapters having a threaded exterior to install to a housing and a threaded interior to receive a threaded fastener length). Particularly when the housing is formed from magnesium having a protective coating, through holes 273 may be employed to allow clamping of a flange and nut that adapts the hole to a standard thread without breaking through the protective coating of the magnesium. This may also allow the holes to be cast-in which may form a completely nonporous skin over the hole's surface. A sealing device (e.g., an O-ring) and/or liquid sealant may be employed to contain the internal dry gas. This allows the thread that an operator may access for accessory attachment to be made of a harder material than magnesium (e.g., fasteners to thread into the adapters 270 may be made from the material harder than magnesium). In addition, it allows inexpensive repair should a thread ever be damaged.

Referring briefly to FIG. 2D, the adapter 270 may provide a threaded hole in which the fastener 276 may be installed, to attach the attachment device 262 (e.g., a rail such as a Picatinny rail accessory, or any uni-directional or bi-directional mounting device) to the housing 200. The fastener 276 may be made from a material different (e.g., harder) than magnesium. Referring again to FIG. 2B, a longer attachment device 261 may be attached in a similar way to an opposite side of the folding optic 205.

In this example, center axes of the interior and exterior holes of the adapters 270 are co-axial. The adapters 270 may be formed from a material that is harder than a material of the housing 200, in some examples.

In this example, the housing 200 also includes integrally formed attachment structures. In particular, the housing 200 defines an undercut attachment structure 3 (e.g., a male undercut attachment structure), which is a male dovetail in this example (e.g., a rail (e.g., an ARCA rail) or some other mounting system that may allow the folding optic to be mounted to a tripod or other platform). The housing 200 also defines a mounting system 2, such as an M-LOK® rail accessory.

Any of the molded housing features described herein can be used in any folded optic having non-coaxial channel sections that are integrally formed (e.g., a monolithic folded optic housing). The housing may be made from any single material, such as magnesium, plastic, or some other material, as desired.

In some embodiments, one of the channel sections may include a lens erector employing a reticle, but this is not required (it may be possible to utilize any lens assembly in the additional channel, in other embodiments). In embodiments including a lens erector employing a reticle, a consistent alignment enabled by monolithic housing may permit the use of reticle as an accurate aiming device for a laser rangefinder or some other accessory and/or modular package coupled to the folded optic.

In the illustrated embodiments, light is re-directed only twice inside the folded optic (e.g., each of the two channels includes a reflector). In other embodiments, it may be possible to use any number of internal reflections of light in a folded optic having a housing with integrally formed channel sections formed from pulled cores of a molding process (e.g., oppositely pulled cores).

In any embodiment described herein reflector assemblies may be employed in order to support new geometries resulting from the reduced distance between the center axes of the non-coaxial channels. In some examples, the housing may define reflector openings, such as threaded reflector openings 128 and 129 (FIG. 1C) to receive threaded reflector assemblies. FIG. 2D illustrates reflector assemblies 228 and 229 installed in threaded openings defined by the housing 200. In other examples, reflector openings may be arranged by some other attachment methods (e.g., bayonet attachment methods).

In various embodiments, any reflector assembly may be pivotable/tiltable (e.g., an adjustable reflector assembly), and may have their angle calibrated during manufacturing to optimize the light path. Once calibrated, the adjustable reflector assemblies may be locked into place at the calibrated angle (as a manufacturing step). Reflectors need not be adjustable in some embodiments, however. In some examples, it may be possible to use fixed reflector assemblies (e.g., not adjustable), which may install in threaded openings defined by a monolithic molded housing similar to any housing described herein.

In various embodiments of a folded light path spotting scope, a solid, one piece housing may be provided, which may avoid any potential movement of optics that could result in a point of aim shift of the reticle in relation to externally mounted devices such as lasers and laser rangefinders. In some embodiments, optical assemblies may be cylindrical in shape, following the round shape of lens that is both functional and easiest to manufacture. These cylindrical assemblies need to fit into cylindrical channels in the housing that provide stable journals and sealing surfaces for gas containment for fogproof performance. A one piece housing may have a cylindrical opening from the front to allow objective lens assembly installation and a precisely parallel cylindrical opening from the back of the assembly to allow installation of the remaining lens assembly.

Some known folding optics may have separate cylinder channels to receive cylindrically-shaped lens assemblies. However, this may require an abrupt change in a thickness of a wall separating the channels. Such a wall profile may lead to an unacceptable defect rate in single-piece metal casting methods.

While it may be possible to avoid this wall profile by making changes to an exterior of the housing (using an exterior profile resembling a figure-eight profile), such exterior changes may not be desirable for various applications. Some embodiments described herein use an interior feature-intersecting cylinder-shaped channels. This may allow use of a thin wall having a gradually tapering thickness. During a one-piece metal casting process using two cores, a thin, easy to remove web can be left in the metal casting process (to form the intersecting cylinders). This allows an exterior surface profile that can parallel a mildly curved exterior profile. In other embodiments that do not use the metal casting process (e.g., use a polymer molding process), the cores may contact to provide an opening between the channels that does not require removal.

### Adjustable Reflector Module

In optic manufacturing, even in a same production run, there may be slight variances from one optic to the next. These slight variances may occur because source parts have slight variations, or their assembly may have slight variations (such as parts coupled at slight different angles), either or both of which may be within acceptable manufacturing tolerances. These slight variations may not negatively impact operation of the optic in the field within some conventional magnification ranges.

However, as magnification features are continuously improved (e.g., as a magnitude of magnification in optic(s) behind the reflectors increases), even a slight variation in parts (or a slight variance in their position relative to each other) may lead to noticeable differences in image quality and/or boresight error. In other words, these slight manufacturing difference may “present” as reduced image quality or boresight error in the field.

To compensate for these slight manufacturing differences, various embodiments described herein may employ at least one adjustable reflector module (e.g., a module with an adjustable mirror), and individual calibration thereof, to reduce variations in image quality and/or boresight error of a product. In particular, after the folded optic has been completely or substantially assembled, a relative position of that folded optic's adjustable reflector (relative to the fixed reflector and/or the lens assemblies) may be individually selected to compensate for the individual part variation or individual assembly variation specific to that folded optic. Tools such as light beams may be used to individually select the exact position of the reflector (the light beam may travel through the lens assemblies by reflection via the reflectors), and characteristics of this light beam may be observed to select the exact relative position to optimize image quality and/or reduce boresight error given the individual folded optic characteristics).

Once the relative position of the adjustable reflector has been individually selected, and set, the position of that adjustable reflector may never need to be changed again. However, it may possible to change again such as in a re-manufacturing or repair process that may involve re-assembling or replacing parts (which of course may produce a different part variation or assembly variation for that folded optic).

In various embodiments, the adjustable reflector module may have one or more of the following features:
May allow movement of the reflector around a fixed pivot point, e.g., adjustability along more than one axis;
May include an access port that allows in-place adjustment of an adjustment interface of the module from outside an environmentally isolated interior of the optic;
May include a cover that may prevent unintentional manipulation of the adjustment interface after the original adjustment;
May be sealingly coupled (or in some embodiments, integrally formed) with a housing of the folded optic (e.g., sealingly coupled to a one piece or plural piece molded housing), and may hold that seal while being adjusted;
May combinationally (together with a one piece or plural piece molded housing or an assembly thereof) form an enclosure of the folded optic; and/or. May be canted with respect to an optical axis of one or more lens assemblies of the folded optic, which may be optimized for use with any one piece molded housing described herein (which may require a smaller distance between channels than some known two piece molded housings).

This may allow improved magnification as compared to some known folded optics without decreasing image quality and/or without increasing boresight error. In other embodiments, this may be used in lower magnification folded optics to improve image quality and/or decreasing boresight error, as compared to some known lower magnification folded optics.

Although a folded optic may use two or more internal reflections (and thus two or more reflectors), it may be sufficient to use one or more known reflector modules (e.g., fixed reflectors) in combination with the adjustable reflector module in a same folded optic. Of course, in other embodiments, it may be possible and practical to using only adjustable reflectors in a same folding scope.

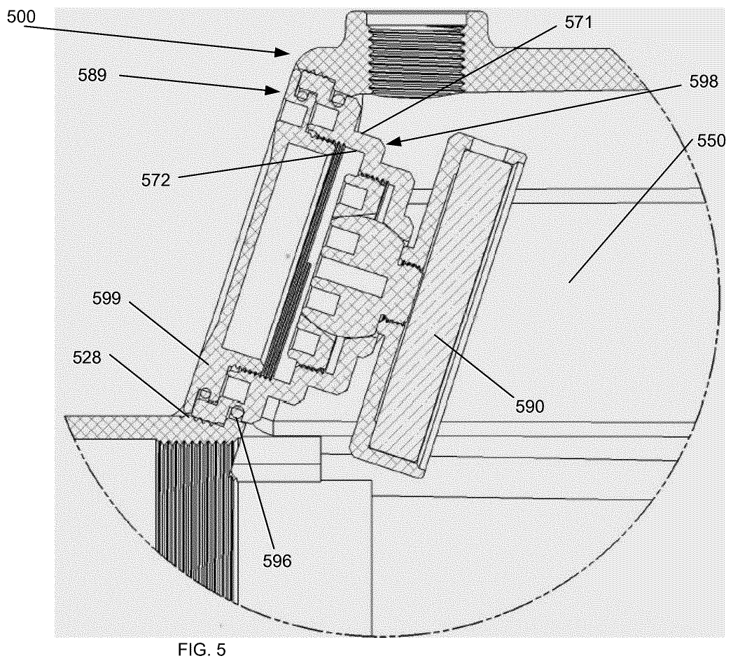

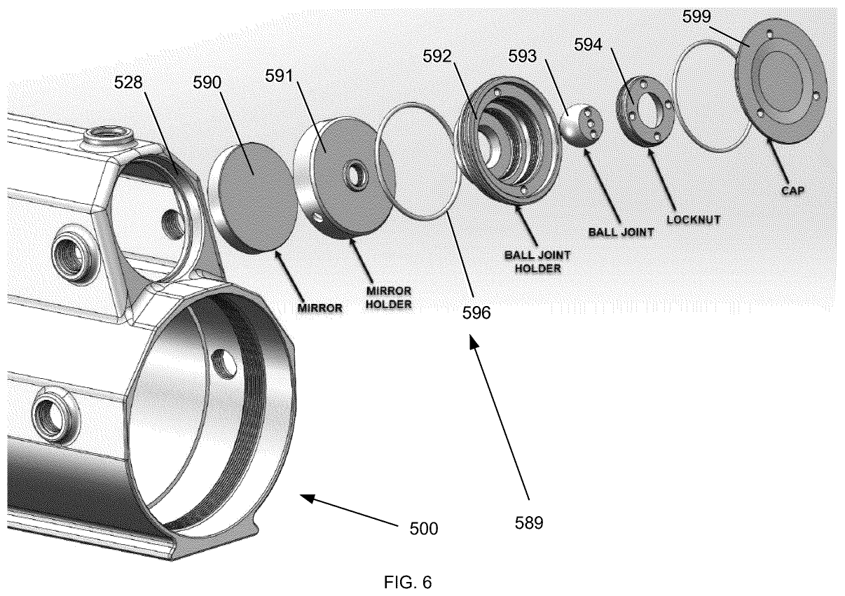

FIG. 5 is a cross section view of an adjustable reflector module 589 installed in a threaded opening defined by a folded optic housing 500, according to various embodiments. FIG. 6 is an exploded view of the adjustable reflector module 589 of FIG. 5.

Referring now to FIG. 5, the folded optic housing 500 (a first housing section) may be similar in any respect to any folded optic housing described herein. In particular, the folded optic housing 500 may be a molded one piece housing. However, this is not required-in other examples, the adjustable reflector module 589 may be used with any folded optic housing, such as a plural piece molded housing or some other folded optic housing or assembly thereof (molded or otherwise).

The adjustable reflector module 589 may include a body 598 (a second housing section) having an interior side 571 located in an environmentally isolated cavity 550, and an exterior side 572 located outside of the environmentally isolated cavity 550. In some examples, the body 598 may be sealingly installed in the threaded opening 528 using a seal 596. The body 598 and the housing 500 (with its various other components fitted into openings therein, not shown) may, in combination, define an enclosure.

In this embodiment, the housing 500 and the body 598 are separate components (e.g., they are first and second housing sections, respectively, of a folded optic); however, this may not be required in other embodiments. It may be possible and practical to provide an integrally formed structure, a part of which includes any features of the adjustable reflector module 589.

In this embodiment, the adjustable reflector module 589 is canted with respect to an optical axis of one or more lens assemblies. This tilt may allow the adjustable reflector module 589 to be used in any one piece molded housing described herein (in which the channels may require closer location to each other than channels of some two piece molded housings). In other embodiments, an adjustable reflector module may have a center axis (e.g., a horizontal axis) that may be non-tilted (e.g., parallel) with respect to an optical axis of one or more lens assemblies.

The adjustable reflector module 589 may include a pivot assembly coupled to the body 598. Referring now to FIG. 6, the pivot assembly may include a ball joint 593, a ball joint holder 592 (which is part of the body 598 of FIG. 5 in this embodiment), and a locknut 594. The ball joint 593 allows pivoting around a fixed point (e.g., more than one axis of adjustment). In other examples, some other pivot assembly to allow pivoting around a single axis may be used.

The pivot assembly may also include a reflector 590 and a support member 591 (e.g., a reflector holder). In this example, the support member 591 is threadably coupled to the front end of ball joint 593, but in other examples the support member 591 may be coupled to the front of a ball joint using any known attachment system, such as fasteners. Also, in other examples, a single part may perform the functions of the ball joint 593 and the support member 591.

The adjustable reflector module 589 may be used in combination with one or more fixed reflectors in a folded optic. Referring to FIG. 2D, the adjustable reflector module 589 may be used in place of reflector assembly 228, and in combination with reflector assembly 229. A reflective surface of the reflector 590 (FIG. 6) may have any characteristics in common with a reflective surface of the reflector of reflector assembly 229. In other embodiments, a folding optic may use more than one adjustable reflector module, such as one in place of each of reflector assemblies 228 and 229.

Referring again to FIG. 5, the adjustable reflector module 589 may include an adjustment interface to pivot the ball joint 593 (FIG. 6). In this embodiment, the adjustment interface is defined by a back end of the ball joint 593. In other embodiments, an adjustable reflector module may have any adjustment interface now known or later developed for positioning the reflective surface of the reflector 590 with the adjustable reflector module in place in a folded optic.

The adjustment interface may be accessed by an access port defined by the adjustable reflector module 589, e.g., by the body 598. This access port may allow in-place adjustment of the reflector 590. The term “in-place” is meant to denote that the adjustable reflector module 589 and/or other components of the folded optic (such as lens assemblies and other reflector assemblies) remain installed in the folded optic while the attachment interface is operated.

In this embodiment, the body 598 may be formed from a different material than a molded housing. For example, the housing 500 may be formed from molded magnesium or molded plastic, and the body 598 may be formed from aluminum. In some embodiments, a metal of the body 598 may be anodized to prevent reaction with the magnesium housing.

In this embodiment, where the body 598 has an annular shape, the adjustable reflector module 589 may be installed into the housing 500 without an adapter. In other embodiments, in may be possible and practical to use a differently shaped body 598, such as with the two piece housing described with reference to FIG. 3A (where an end of the top piece has a tombstone shape).

The position of the reflector 590 may be selected using tools such as a laser, multi-spectrum light source, a light beam, collimated light scope. In one embodiment, a folded optic is completely or substantially assembled (e.g., when the relative location of the adjustable reflector module and other part(s) of the folding optic is fixed). In some examples, the adjustable reflector module 589 may be fixably or non-removably installed into the threaded opening 528 (e.g., with the use of a thread adhesive which must be broken to separate the adjustable reflector module 589 from the housing 500). In one example of substantial assembly, the locknut 594 (FIG. 6) may be installed loosely to allow pivoting to optimize a position of the mirror 594.

Next, a light beam may be projected though the folded optic (e.g., into the lower channel). With the cap 599 removed (not illustrated), and in some cases while the light beam is projected through the folded optic, the attachment interface may be operated through the access port. The attachment interface may be operated until operational characteristics indicated by the light beam are within desired thresholds. This may individually tune the folded optic to compensate for slight variances in its parts or their positions relative to each other. The locknut 594 may be tightened from the outside once the reflector 590 has been optimally positioned.

Once tuning is complete, the cap 599 can be reattached to block access to the access port. In this embodiment, the cap 599 is sealingly attached to the body 598 using one of the seals 596 that is in contact with the cap 599. In various embodiments, the cap 599 may be fixably or non-removably installed (e.g., using a thread adhesive that must be broken to separate the cap 599 from the body 598). However, an applied adhesive may be broken, if needed, to re-select a position of the reflector 590 if needed (e.g., if the relative position is changed, such as if the lens assemblies are replaced in a repair).

In some of the embodiments described herein, the adjustable reflection module is used with folded optic having the high magnification capability previously described. However, in other embodiments, the adjustable reflector module and methods described herein may be used with lower magnification folded optics. This could allow manufacturing tolerances for one or more components or assembly processes for the lower magnification folded optic to be relaxed if needed to enable overall cost reduction and/or entry into lower end markets (by using a tuning process to ensure that lower magnification folded optics do not suffer observable performance loss due to manufacturing variations.

In the illustrated embodiments, the illustrated folded optic housing 500 includes a threaded opening (a threaded attachment interface) to receive the adjustable reflector module 589. In other embodiments, any optic housing described herein may include a non-threaded attachment interface (e.g., a female non-threaded interface) to mate with a corresponding non-threaded attachment interface of an adjustable reflector module (e.g., a male non-threaded interface). As one example, a bayonent mounting interface may be used to attach the adjustable reflector module to the optic housing. Any other threaded or non-threaded attachment interfaces, now known or later developed, may be used to attach (e.g., sealingly couple) an adjustable reflector module to an optic housing in various embodiments.

### Foldable Attachment Assembly

In place of the attachment device 261 (FIG. 2A), any folded light path optic described herein may be used in combination with the folding attachment assembly 761 illustrated in FIGS. 7, 8A, 8B, 9, 10A, 10B, 11A, and 11B in a folded light path optic assembly. In the unfolded state, the folding attachment assembly 761 may operate similarly in any respect to the attachment device 261. For example, in the unfolded state, a first mounting system of a first mounting section 711, such as an Picatinny rail accessory, is available for attachment of rail-mountable accessories to the folded light path optic assembly. Also, using a second mounting system of a second mounting section 712, an interface such as the illustrated ARCA rail may be usable to mount the folded light path optic assembly to a tripod or other platform.

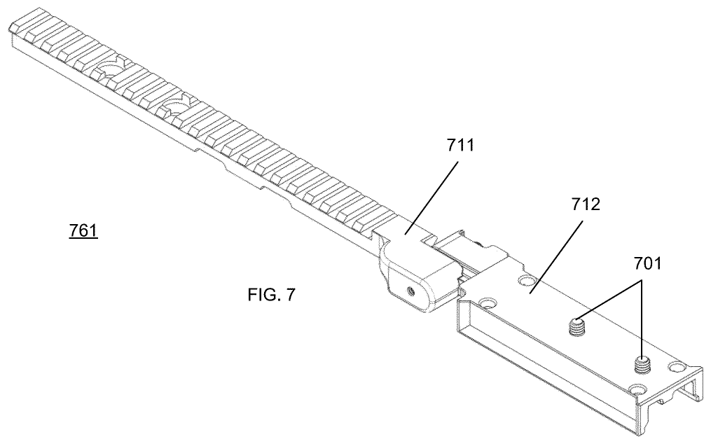

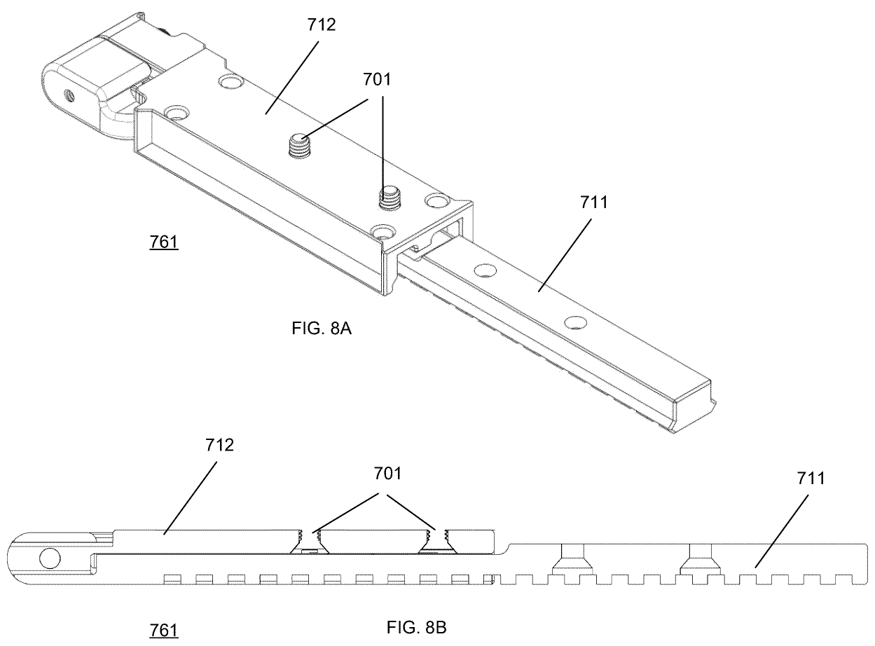

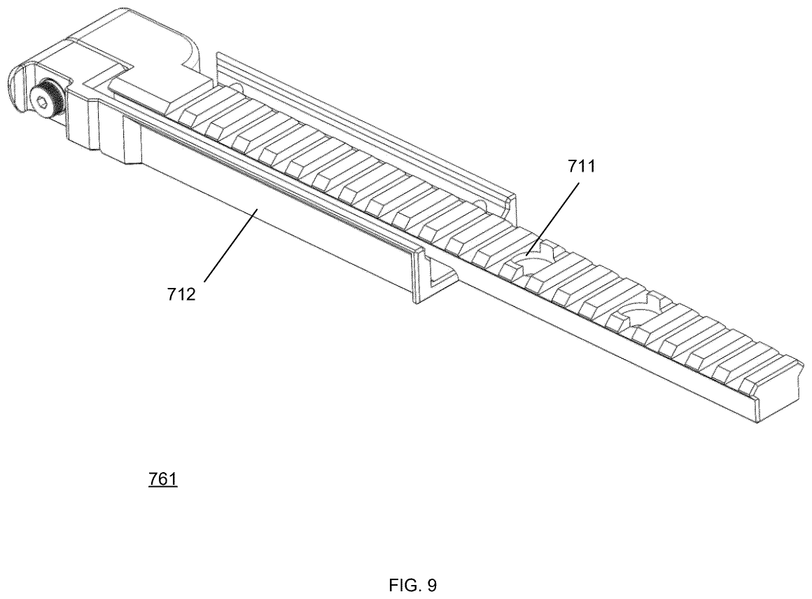

A female interface of the second mounting section 712 may include a channel or other space to receive a mating male interface of the tripod or other platform. At least a portion of a length the first mounting section 711 may be located in this channel or other space in the folded state, as illustrated in FIGS. 8B and 9. By folding into that channel or other space as illustrated, a height dimension of the folding attachment assembly 761 in the folded state may be optimized (by locating the length completely into that channel or other space as illustrated or other partially into that channel or space in other embodiments). For example, in the illustrated embodiment, a height dimension of the folding attachment device 262 may be approximately the same in both states. However, folding completely or partially into the channel or other space is not required, and in other embodiments a height dimension of the folding attachment device 262 may be greater in the folded state than the unfolded state. Of course, in any case, another dimension of the folding attachment assembly (e.g., a length) may be less in the folded state than the unfolded state. It is noted that an illustration of the fasteners 701 has been truncated in FIG. 8B, for clarity.

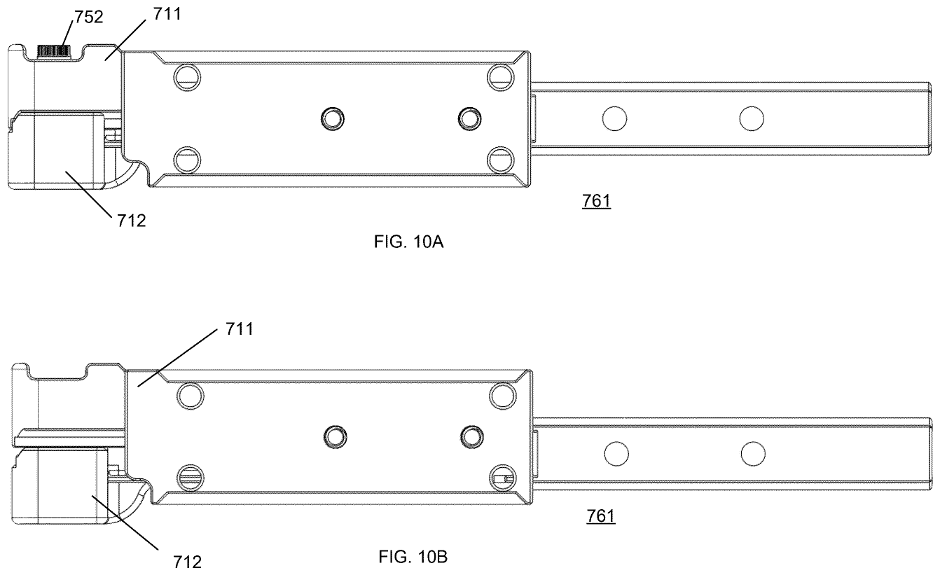

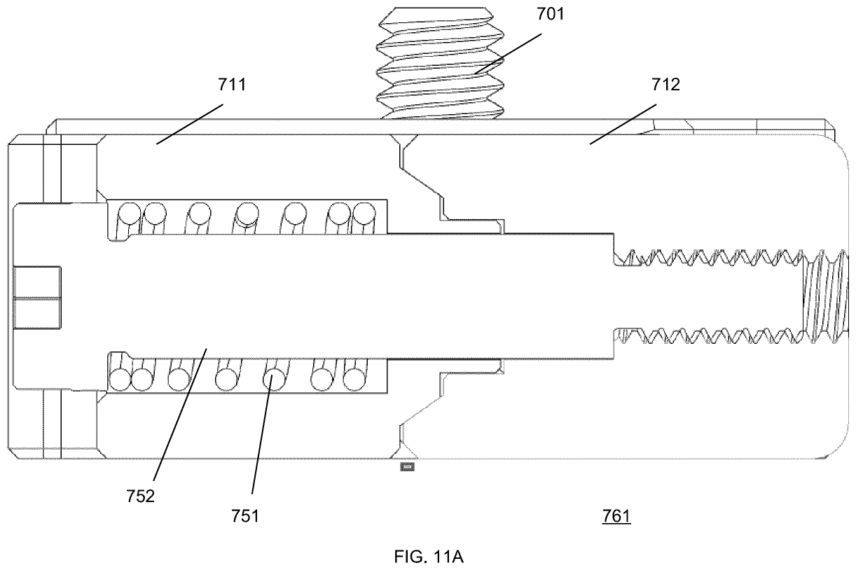

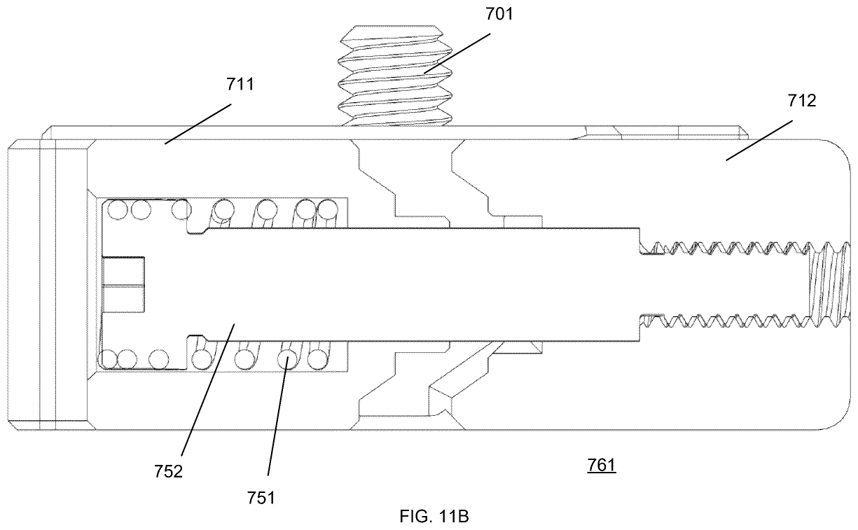

Referring now to FIGS. 10A, 10B, 11A, and 11B, to pivot the first mounting section 711 in a counter clockwise direction to relative to the second mounting section 712, a user may first release the folding attachment assembly 761 into the unlocked state (FIGS. 10B and 11B). Referring to FIGS. 11A and 11B, in various embodiments, unlocking may include separating mounting sections 711 and 712, which may be by pushing the head of threaded part 752 against the spring force of coil spring 751 in some embodiments.

Once unlocked, the first mounting section 711 may be pivoted relative to the second mounting section 712 (e.g., pivoted in a counterclockwise direction). As illustrated, the first mounting section 711 may make relative movement with respect to a threaded part 752 when transitioning from the locked position to the unlocked position. Comparing FIGS. 10A and 10B, one can see that an end of the threaded part 752, opposite the threaded end of the threaded part 752, protrudes from the first mounting section 711 in the locked state but not in the unlocked state.

It should be understood that any folding attachment assembly features described herein may be used in combination with any folded light path optic, now known or later developed. It should also be understood that any folding attachment assembly features described herein may be used in combination with any firearm or other optic. For instance, the folding attachment assembly features may be used in combination with any a firearm optic now known or later developed (such as a scope or an optic sight), or some other optic product now known or later developed, in which optic product is configured to have a part mounted to a first interface thereof and the optic product is mountable to a tripod or other platform using a second interface of the optic product.

### EXAMPLES

The illustrated embodiments describe some examples within the scope of the disclosure of the present application. However, other embodiments within the scope of this disclosure may include any one of the following examples.

Example 1 is a manufacture formed using a mold and plural cores, the manufacture comprising: a monolithic housing having ends and a length, the length defining a plurality of non-coaxial channels including: an objective channel for an objective lens assembly; and an additional channel for an additional lens assembly; the monolithic housing further including: a first core opening at an end of the ends, wherein the first core opening is configured to receive the objective lens assembly; and a second core opening at another end of the ends, wherein the second core opening is configured to receive the additional lens assembly.

Example 2 is the manufacture of example 1 or any other example herein, the monolithic housing further comprising a first reflector opening to locate a first reflector and a second reflector opening to locate a second reflector to re-direct reflected light from the first reflector through the additional lens assembly.

Example 3 is the manufacture of any of examples 1-2 or any other example herein, wherein the monolithic housing comprises a monolithic metal housing.

Example 4 is the manufacture of any of examples 1-3 or any other example herein, wherein the monolithic housing comprises a monolithic plastic or other non-metal housing.

Example 5 is the manufacture of any of examples 1-4 or any other example herein, wherein exterior bottom side of the length of the monolithic housing defines a mounting rail interface.

Example 6 is the manufacture of any of examples 1-5 or any other example herein, wherein the mounting rail interface comprise a dovetail rail.

Example 7 is the manufacture of any of examples 1-6 or any other example herein, wherein an exterior part of the length of the monolithic housing defines one or more openings having one or more adapters mounted thereto, respectively; wherein each adapter includes: an exterior to mate with a corresponding one of the one or more openings; and a threaded hole for mounting an optic accessory to the manufacture, the threaded hole to mate with a threaded length of a fastener of the optic accessory.

Example 8 is the manufacture of any of examples 1-7 or any other example herein, wherein at least one of the one or more adapters is ring-shaped, and wherein a center axis of the threaded hole is co-axial with a corresponding opening of the one or more openings.

Example 9 is the manufacture of any of examples 1-8 or any other example herein, wherein the monolithic housing is formed from a first material, and wherein the one or more adapters receive one or more threaded lengths of one or more fasteners, the one or more fasteners formed from a second material that is different than the first material.

Example 10 is the manufacture of any of examples 1-9 or any other example herein, wherein the second material has a hardness that is greater than the first material.

Example 11 is the manufacture of any of examples 1-10 or any other example herein, wherein a distance between center axes of the first and second openings is not greater than one half of a sum of a width of the first opening and a width of the second opening.

Example 12 is the manufacture of any of examples 1-11 or any other example herein, wherein a sidewall of at least one of the channels has a tapering thickness, in which the thickness increases moving away from a corresponding one of the core openings.

Example 13 a folded optic comprising the manufacture of any of examples 1-12 or any other example herein.

Example 14 is a folded optic, comprising: a housing having ends and a length, wherein the housing includes: an objective channel section defining an objective channel; and an additional channel section integrally formed with the objective channel section, the additional channel section defining an additional channel that is non-coaxial with the objective channel; an objective lens assembly mounted to the objective channel section; and an additional lens assembly mounted to the additional channel section.

Example 15 is the folded optic of example 14 or any other example herein, further comprising an asymmetrical baffle located in the additional channel section.

Example 16 is the folded optic of any of examples 14-15 or any other example herein, further comprising an asymmetrical baffle located in the objective channel section.

Example 17 is the folded optic of any of examples 14-16 or any other example herein, wherein an exterior of the additional channel section defines a mounting rail interface or other bi-directional mounting interface.

Example 18 is the folded optic of any of examples 14-17 or any other example herein, wherein an exterior of the one of the channel sections includes one or more openings having one or more adapters mounted thereto, respectively; wherein each adapter includes: an exterior to mate with a corresponding one of the one or more openings; and a threaded hole for mounting an optic accessory to the manufacture, the threaded hole to mate with a threaded length of a fastener of the optic accessory.

Example 19 is the folded optic of any of examples 14-18 or any other example herein, wherein the housing comprises a die-cast metal housing or an injection molded plastic housing.

Example 20 is the folded optic of any of examples 14-19 or any other example herein, wherein the assemblies are mounted to openings of the channels; wherein a distance from center axes of the openings is less than one half of a sum of widths of the openings.

Example 21 is a folded optic having 1) an objective channel section including an objective lens assembly and 2) a non-coaxial additional channel section including an additional lens assembly, the folded optic comprising: a housing defining an environmentally-isolated cavity, the housing including: a first housing section containing the lens assemblies; and a second housing section having an interior side located in the environmentally-isolated cavity and an exterior side located outside the environmentally-isolated cavity; a reflector to redirect light processed by the objective lens assembly to the additional lens assembly; wherein the reflector is pivotably mounted to the interior side of the second housing section, and wherein the exterior side of the second housing section defines an access port exposing an adjustment interface to select a position of the reflector.

Example 22 is the folded optic of example 21 or any other example herein, further comprising a cover to close the access port.

Example 23 is the folded optic of examples 21-22 or any other example herein, wherein the cover is attached, fixably, to the second housing section, the fixable attachment to prevent post-manufacturing access to the adjustment interface.

Example 24 is the folded optic of examples 21-23 or any other example herein, wherein the adjustment interface is defined by a back end of a ball joint.

Example 25 is the folded optic of examples 21-24 or any other example herein, wherein the reflector is mounted to a front end of the ball joint.

Example 26 is the folded optic of examples 21-25 or any other example herein, an adjustable reflector module comprising at least one body and at least one support member pivotably attached thereto, the support member having the reflector thereon; wherein the second housing section comprises the at least one body.

Example 27 is the folded optic of examples 21-26 or any other example herein, wherein the first housing section comprises a molded housing defining an opening and the second housing section comprises at least one body installed in the opening.

Example 28 is the folded optic of examples 21-27 or any other example herein, wherein the molded housing is formed from a first material comprising metal or plastic, and the at least one body is formed from a second material that is different than the first material.

Example 29 is the folded optic of examples 21-28 or any other example herein, wherein the metal comprises magnesium.

Example 30 is the folded optic of examples 21-29 or any other example herein, wherein the second material comprises anodized aluminum.

Example 31 is the folded optic of examples 21-30 or any other example herein, wherein the second housing section comprises a ball joint holder.

Example 32 is the folded optic of examples 21-31 or any other example herein, further comprising a ball joint having a first ball joint section located in the ball joint holder and a second attachment section, wherein the reflector is mounted to the second attachment section.

Example 33 is the folded optic of examples 21-32 or any other example herein, further comprising a reflector holder affixed to the attachment section, wherein the reflector is installed in the reflector holder.

Example 34 is the folded optic of examples 21-33 or any other example herein, wherein the second housing section is threadably coupled to the first housing section.

Example 35 is the folded optic of examples 21-34 or any other example herein, wherein an opening defined by the second housing section is canted with respect to an optical axis of a lens of the additional lens assembly; and wherein the first housing section is installed in the canted opening.

Example 36 is an adjustable reflector module installable in an opening defined by single or plural piece molded housing containing an objective lens assembly and a non-coaxial additional lens assembly, the adjustable reflector module comprising: a body to, together with the single or plural piece molded housing, define an environmentally-isolated cavity; a reflector on an interior side of the body, the reflector located in the environmentally isolated cavity when the adjustable reflector module is installed in the opening, the reflector to redirect light processed by the objective lens assembly to the additional lens assembly; an adjustment interface on an exterior side of the body, the adjustment interface to pivot the reflector relative to the body.

Example 37 is the folded optic of example 36 or any other example herein, the adjustment interface to pivot the reflector relative to the body along more than one axis.

Example 38 is the folded optic of examples 36-37 or any other example herein, further comprising a cover to block access to the adjustment interface.

Example 39 is the folded optic of examples 36-38 or any other example herein, wherein the cover is attachable, fixably, to the exterior of the body, the fixable attachment to prevent post-manufacturing access to the adjustment interface.

Example 40 is the folded optic of examples 36-39 or any other example herein, wherein a housing assembly of the scope or other optical device comprises a housing formed from at least one molded part.

Example 41 is a folding attachment assembly couplable with a firearm optic or some other optic product to provide a firearm optic assembly or optic product assembly, in which the firearm optic assembly or optic product assembly includes a first mounting section having a first interface for mounting a part thereto and a second mounting section having a second interface for mounting the firearm optic assembly or other optic product assembly to a tripod or other platform. The first and second mounting sections may be hingably attached, in which one of the mounting sections may be unlocked to pivot relative to the other mounting section to reduce a total length of the folding attachment assembly and/or the firearm optic assembly or optic product assembly.

Example 42 is the folding attachment assembly of example 41 in which one of the mounting sections defines a space and in which a portion of a length of the other mounting section is located in the space in the folded state. In various embodiments, the space may include a channel or other volume defined by a female interface of the first mounting interface.

Example 42 is the folding attachment assembly of examples 41-42 or any other example herein, in which the folding attachment assembly is unlockable by separating the mounting sections, which may be by pushing a head of a retention device to partially collapse a spring. The folding attachment assembly may be lockable by releasing the one of the mounting sections so that it is urged toward the other mounting section by the spring.

Example 43 is a scope or other firearm optic device including the folding attachment assembly of any of examples 41-43.

Example 44 is a firearm optic device or other optic product including the folding attachment assembly of any of examples 41-43.

It will be obvious to those having skill in the art that many changes may be made to the details of the above-described embodiments without departing from the underlying principles of the invention. The scope of the present invention should, therefore, be determined only by the following claims.

1. An adjustable reflector module installable in an opening defined by single or plural piece molded housing containing an objective lens assembly and a non-coaxial additional lens assembly, the adjustable reflector module comprising:
a body to, together with the single or plural piece molded housing, define a cavity;
a reflector on an interior side of the body, the reflector located in the cavity when the adjustable reflector module is installed in the opening, the reflector to redirect light processed by the objective lens assembly to the additional lens assembly;
an adjustment interface on an exterior side of the body, the adjustment interface to pivot the reflector relative to the body.

2. The adjustable reflector module of claim 1, the adjustment interface to pivot the reflector relative to the body along more than one axis.

3. The adjustable reflector module of claim 1, further comprising a cover to block access to the adjustment interface.

4. The adjustable reflector module of claim 3, wherein the cover is sealingly attachable, fixably, to the exterior of the body, the fixable attachment to prevent post-manufacturing access to the adjustment interface, wherein sealingly and fixably attaching the cover to the exterior of the body environmentally-isolates the cavity.

5. A scope or other optical device including the adjustable reflector module of claim 1, wherein a housing assembly of the scope or other optical device comprises a housing formed from at least one molded part.

6. A folding attachment assembly configured to couple to a scope or other optical device that includes the adjustable reflector module of claim 1, wherein the folding attachment assembly includes a first mounting section hingably coupled to a second mounting section;
wherein the first mounting section includes a first interface to removably couple a part to the folding attachment assembly and the second mounting section includes a second interface to removably couple to a tripod or other mounting platform.

7. The folding attachment assembly of claim 6, wherein the first mounting section defines a space, and wherein a portion of a length of the second mounting section is located in the space in a folded state of the folding attachment assembly.

8. The folding attachment assembly of claim 7, wherein a height of the folding attachment assembly is approximately the same in the folded state and an unfolded state of the folding attachment assembly.

9. The folding attachment assembly of claim 7, wherein the space comprises a channel or other portion of a female interface configured to receive a mating male interface associated with said part.

10. The folding attachment assembly of claim 7, further comprising a spring to urge one of the mounting sections toward the other mounting section in an unlocked state, wherein the folding attachment assembly lockable by releasing a force, applied by a user, to allow the spring to expand.

11. A folded optic having 1) an objective channel section including an objective lens assembly and 2) a non-coaxial additional channel section including an additional lens assembly, the folded optic comprising:
a housing defining a cavity, the housing including:
a first housing section containing the lens assemblies; and
a second housing section having an interior side located in the cavity and an exterior side located outside the cavity;
a reflector to redirect light processed by the objective lens assembly to the additional lens assembly;
wherein the reflector is pivotably mounted to the interior side of the second housing section, and wherein the exterior side of the second housing section defines an access port exposing an adjustment interface to select a position of the reflector.

12. The folded optic of claim 11, further comprising a cover to close the access port.

13. The folded optic of claim 12, wherein the cover is attached, fixably, to the second housing section, the fixable attachment to prevent post-manufacturing access to the adjustment interface.

14. The folded optic of claim 13, wherein the adjustment interface is defined by a back end of a ball joint.

15. The folded optic of claim 14, wherein the reflector is mounted to a front end of the ball joint.

16. The folded optic of claim 11, an adjustable reflector module comprising at least one body and at least one support member pivotably attached thereto, the support member having the reflector thereon;
wherein the second housing section comprises the at least one body.

17. The folded optic of claim 16, wherein the first housing section comprises a molded housing defining an opening and the second housing section comprises at least one body installed in the opening.

18. The folded optic of claim 11, wherein the second housing section comprises a ball joint holder.

19. The folded optic of claim 18, further comprising a ball joint having a first ball joint section located in the ball joint holder and a second attachment section, wherein the reflector is mounted to the second attachment section.

20. The folded optic of claim 11, wherein an opening defined by the second housing section is canted with respect to an optical axis of a lens of the additional lens assembly; and
wherein the first housing section is installed in the canted opening.
